(19) United States
(12) Patent Application Publication
(10) Pub. No.: US 2009/0014253 A1
(43) Pub. Date: Jan. 15, 2009

(54) Braking mechanism for moving assemblies

(76) Inventor: Louis Morrissette, Candiac (CA)

Correspondence Address: Franz Bonsang;C/o Equinox Protection, 410-1500, Du College, St-Laurent (Quebec), H4L 5G6, CA

(21) Appl. No.: 11/794,242

(22) PCT Filed: Dec. 23, 2005
(86) PCT No.: PCT/CA05/01966

§ 371 Date: Jun. 27, 2007

Related U.S. Application Data
(60) Provisional application No. 60/638,392, filed on Dec. 27, 2004.

(51) Int. Cl. B66B 5/24; B66B 5/18; B66B 5/04; B66F 17/00

(52) U.S. Cl. 187/374; 187/373; 187/376

(57) ABSTRACT

A braking mechanism (10) for the moving structure (22) of a moving assembly comprises an elongated member (28) provided with a scroll (34) for mating engagement with coupling means (46) formed on a ring (44) which is freely capable of rotating around the member (28) and therealong during normal operation of the relevant moving structure (22). The ring (44) is included within a guide structure (36) attached to the moving structure (22) and also comprising an engagement element (42) with which the ring (44) engages when the moving structure (22) exceeds a predetermined speed. A bearing (40) is associated with the guide structure (36) and provided on and around the engagement element (42) for the ring (44) in order to facilitate travel along the elongated member (28).

### FIELD OF THE INVENTION

The present invention relates to braking devices and methods and is more particularly concerned with a braking mechanism for use in an emergency situation to decelerate and arrest the motion of an assembly traveling along a set path, for example a vertical path.

### BACKGROUND OF THE INVENTION

It is well known in the art to use braking systems for a moving apparatus used in the lifting of goods or persons, opening or closing an access, etc., wherein a vertical height difference is present. In most industrial equipment, the stopping action is often activated by an automatic or manual command, immobilizing the equipment by switching off or putting on hold the powering output of the moving apparatus. This action is therefore controlled. Many types of equipment however lack a simple system for immobilizing the moving elements of the equipment without damage when a component malfunctions or breaks. The moving element then falls under the influence of gravity and may fall rapidly with adverse consequences, for example inter alia rendering unusable the apparatus and preventing the proper future functioning thereof, potentially injuring persons, damaging costly running equipment, causing delays in production, etc. In another and important aspect, the moving element may go into an unwanted rapid descent in the absence of any breakage but with similar consequences. Furthermore, the moving elements of the equipment may encounter a foreign object in their path thereby damaging the equipment and the foreign object.

Some examples of apparatus where such devices would be appropriate includes, but are not restricted to, industrial and building elevators, lifting devices, e.g. hoists and cranes, applicable to transporting and lifting goods or people, or for moving objects. Other useful applications include the operation of large shed or depot doors, lifeline systems used in high-rise buildings maintenance, car lifts, etc.

Emergency braking systems for some equipment are customized and may require many complex and expensive additional components. For a variety of other such equipment, emergency braking systems are not readily available and thus need to be adapted from other types of machinery or custom-built as indicated supra.

There are other kinds of equipment where emergency arrest devices would be beneficial, for example in the field of exercise apparatus where heavy weights are deployed for body building and general fitness purposes. In this field, it is common to suspend weights in elevation in some machines above the user and in the event of equipment malfunction or user failure to accommodate the weights selected, an arrest device and/or a speed control device actuatable at any position of the weights would be a valuable safety feature to prevent injury.

There already exist proposals for arrest devices, for example as disclosed in U.S. Pat. No. 5,570,758 to Nussbaum who describes an arrester nut involving the use of recirculating balls within a thread formed on a vertical static arrester rod. The nut requires to be spring-loaded in order to effect descent thereof along the rod and indeed is held captive between two open-coil compression springs within a housing embracing the rod, and the calibration is dependent on the proper selection of the springs.

I have already devised braking systems as exemplified in International Patent Application Publication No. WO 2005/026032 which describes an arrest device including the interaction of an arm and a stopper to initiate the braking effect in an emergency situation.

Accordingly, there is a need for an improved braking mechanism for moving assemblies of greater simplicity with a concomitant enhancement of effectiveness for safety and protective purposes, and for use in a wider range of applications.

### SUMMARY OF THE INVENTION

It is therefore a general object of the present invention to provide an improved braking mechanism for moving assemblies.

An advantage of the present invention is that the braking mechanism for moving assemblies can be installed along a moving assembly that has a substantially vertical orientation, or indeed on such an assembly disposed along a gradient, for example a conveyor or moving stairways, or even an horizontal orientation such as an horizontal portion of a cable or the like.

Another advantage of the present invention is that the braking mechanism for moving assemblies can be efficiently used for a large variety of systems.

A further advantage of the present invention is that the braking mechanism for moving assemblies engages when the moving assemblies undergo a sudden and unforeseen speed change reaching a speed beyond the normal operational speed range or above a predetermined speed value, typically relative to an elongated member.

Another advantage of the present invention is that the braking mechanism for moving assemblies, once activated, remains activated by the weight of the moving assembly itself being retained thereby, and as long as the weight remains suspended, the elongated member or cable being strong enough to sustain such a static load.

A further advantage of the present invention is that the braking mechanism for moving assemblies is that it can be activated at any position of the moving assembly along its displacement course, as opposed to discrete positions.

Yet another advantage of the present invention is that the braking mechanism for moving assemblies is a passive mechanism that does not need to be activated at each time the moving assembly is used, it is always there in case of failure or the like.

Still another advantage of the present invention is that the braking mechanism for moving assemblies protects the moving assemblies and surroundings.

Another advantage of the present invention is that the braking mechanism for braking assemblies is simple, easy to be installed on existing systems and less expensive to manufacture.

Still a further advantage of the present invention is that the braking mechanism for moving assemblies does not require additional parts or modifications that are not directly related to the braking mechanism.

Yet another advantage of the present invention is that the braking mechanism for moving assemblies further allows for speed control of the relative displacement, up and/or down) of the moving assemblies with the respective supporting structure, especially in weight lifting apparatuses or the like.

According to a first aspect of the present invention, there is provided a braking mechanism adapted for connection to a moving structure of a moving assembly, the braking mechanism comprising an elongated member and a guiding structure characterized by the guiding structure being connectable to the moving structure and freely movable axially along the elongated member and comprising a ring connected by a coupling means to the elongated member, the coupling means in use allowing unimpeded rotation of the ring around and displacement thereof along the elongated member when the moving structure axially moves at or below a predetermined speed, the guiding structure further comprising an engagement element engageable with the ring when the moving structure moves above the predetermined speed thereby generating a rotation resistance force therebetween, whereby the rotation resistance force slowing down or arresting the displacement of the ring and of the guiding structure on the elongated member, and of the moving structure of the moving assembly. Typically the rotation resistance force is a frictional force.

The ring and the engagement element may be of planar form or in the alternative may be frusto-conical form with a respective one of the ring and the engagement element being for male or female coupling. The frusto-conical format may be normally presented or inverted.

The engagement element and/or the ring may be formed of high friction material, for example rubber or other brake material currently available.

The elongated member may in the form of a rigid rod provided with a thread or scroll for mating association with the coupling means on the ring. In the alternative, the elongated member may be relatively flexible, for example the member may be constituted by a wire rope or twisted cable with sufficient scroll to enable functioning of the coupling means on the ring to engage the rope.

The guiding structure includes a bearing arrangement circumscribing the elongated member and in use capable, during normal ascent or movement of the structure, of contacting and supporting the ring during its rotation about the elongated member.

The ring may be provided with mounting means for weights such as to vary the rate of descent of the ring when the braking mechanism is used in exercise apparatus or the like.

The braking mechanism may have an externally activated safety mechanism is provided to position the ring in a close proximity with the engagement element to enable instantaneous engagement therebetween, the safety mechanism being optionally actuated dependent upon the degree of braking security required. Alternatively, the safety mechanism is provided to give assistance to secure the ring and the engagement element in contact engagement during the arresting mode. The safety mechanism may typically be pneumatically or hydraulically, or electromagnetically activated. In the alternative, a mechanical locking may be adopted, such for example as a ratchet arrangement appropriately disposed as between the ring and the engagement element.

Further the ring or the engagement may be resiliently, e.g. spring, supported.

Sensors may be provided intermediate the ring and the engagement element to monitor their relative movement to initiate a prior warning of imminent contact therebetween signaling a failure in the system and an emergency situation.

In a second aspect of the present invention, there is provided a braking mechanism adapted for connection to a moving structure of a moving assembly, the braking mechanism comprising an elongated member and a guiding structure characterized by the guiding structure being connectable to the moving structure and freely movable axially along the elongated member and comprising a ring connected by a coupling means to the elongated member, the coupling means in use allowing unimpeded rotation of the ring around and displacement thereof along the elongated member when the moving structure axially moves at or below a predetermined speed, the guiding structure further comprising an extension and an engagement element mounted thereon, said engagement element engaging the ring upon said extension contacting an obstruction, thereby generating a frictional force between the ring and the engagement element, the frictional force slowing down or arresting the displacement of the ring and of the guiding structure on the elongated member, and of the moving structure of the moving assembly.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a partial schematic side elevation view of a braking mechanism for moving assemblies in accordance with an embodiment of the present invention showing a moving assembly in operative condition and the braking mechanism not activated;

FIG. 1a is an enlarged section view taken along line 1a-1a of FIG. 1 showing the protrusion of the ring in relation with the elongated member;

FIG. 2 is a partial schematic side elevation view of the embodiment of FIG. 1 showing the moving assembly in a non-operative and unstable condition and the braking mechanism activated;

FIG. 3 is a partial schematic side elevation view of the embodiment of FIG. 1 showing the moving assembly in a non-operative and stable condition and the braking mechanism activated;

FIG. 4 is a partial schematic side elevation view according to a second embodiment of the present invention showing the moving assembly in operative condition and without interference and the braking mechanism not activated;

FIG. 5 is a partial schematic side elevation view of the embodiment of FIG. 4 showing the moving assembly in a non-operative condition and with interference and the braking mechanism activated;

FIG. 6 is a partial schematic side elevation view according to a third embodiment of the present invention showing the moving assembly in operative condition and the braking mechanism not activated;

FIG. 7 is a partial schematic side elevation view of the embodiment of FIG. 6 showing the moving assembly in a non-operative and stable condition and the braking mechanism activated;

FIG. 8 is a partial schematic side elevation view according to a fourth embodiment of the present invention showing the moving assembly in operative condition and the braking mechanism not activated;

FIG. 9 is a partial schematic side elevation view of the embodiment of FIG. 8 showing the moving assembly in a non-operative and stable condition and the braking mechanism activated;

FIG. 10 is a partial schematic side elevation view according to a fifth embodiment of the present invention showing the moving assembly in operative condition and the braking mechanism not activated;

FIG. 11 is a partial schematic side elevation view of the embodiment of FIG. 10 showing the moving assembly in a non-operative and stable condition and the braking mechanism activated;

FIG. 12 is a partial schematic side elevation view according to a sixth embodiment of the present invention showing the moving assembly in operative condition and the braking mechanism not activated;

FIG. 13 is a partial schematic side elevation view of the embodiment of FIG. 12 showing the moving assembly in a non-operative and stable condition and the braking mechanism activated;

FIG. 14 is a partial schematic side elevation of a seventh embodiment of the present invention showing the moving assembly in operative condition and the braking mechanism not activated;

FIG. 15 is a partial schematic side elevation of the embodiment of FIG. 14 showing the moving assembly in a non-operative condition with the braking mechanism activated in a safe mode;

FIG. 16 is a partial schematic side elevation of the embodiment of FIG. 14 showing the moving assembly in a non-operative condition with the braking mechanism activated following an emergency situation;

FIG. 17 is a partial schematic side elevation of an eighth embodiment of the present invention showing the moving assembly in an operative condition with the braking mechanism not activated;

FIG. 18 is a partial schematic side elevation of the embodiment of FIG. 17 showing the moving assembly in a non-operative condition and the braking mechanism activated following an emergency situation;

FIG. 19 is a partial schematic side elevation of the embodiment of FIG. 17 showing the moving assembly in a non-operative condition and the braking mechanism activated in a safe mode; and

FIG. 20 is a partial schematic side elevation of a ninth embodiment.

### DETAILED DESCRIPTION OF THE PREFERRED EMBODIMENTS

With reference to the annexed drawings the preferred embodiments of the present invention will be herein described for indicative purpose and by no means as of limitation.

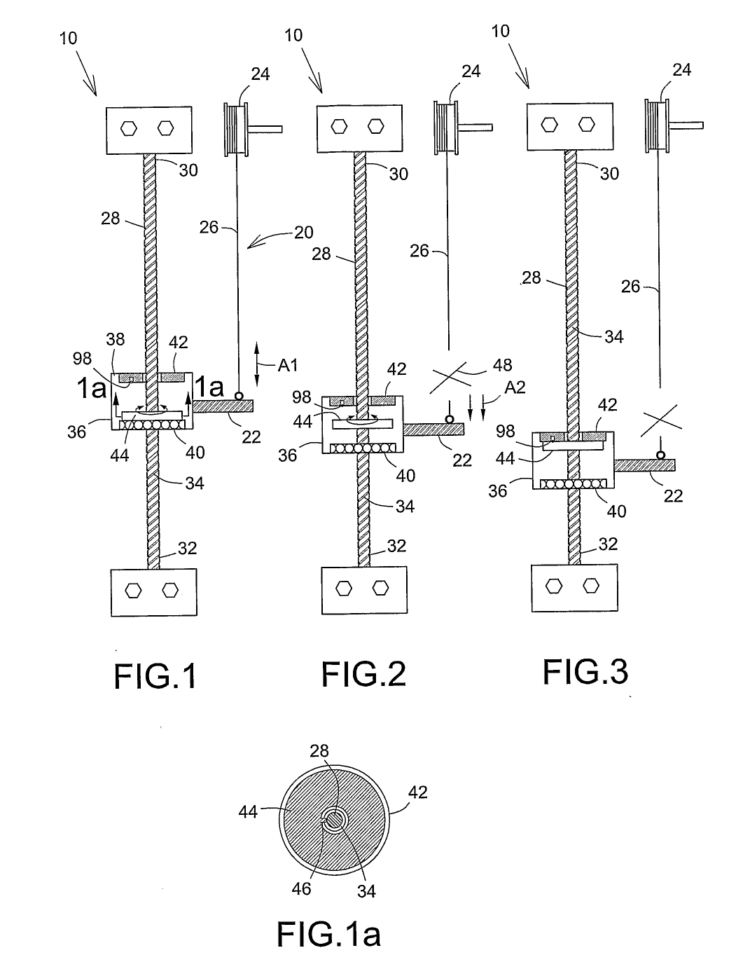

Referring to FIGS. 1 through 3, there is schematically shown a braking mechanism 10 in accordance with an embodiment of the present invention along with a moving assembly 20. The moving assembly 20 comprises a moving structure 22 and at least one actuating means 24. The moving assembly 20 represents many industrial types of equipment in which the moving structure 22 follows under normal operating conditions a generally vertical gradient displacement represented in FIG. 1 by a double-headed arrow A1. The moving structure 22 represents for example a supporting platform for persons or merchandise, a door for an airplane shed or the like. In the latter example, one skilled in the art will understand that the moving structure 22 depicted schematically in FIG. 1 represents only for instance a cross-bar of the door, for example. Furthermore, the door and cross-bar could also move in other axial directions not shown. The actuating means 24 which represents a winch, winding rod or the like and combined to other equipment such as a motor (not shown) is linked to the moving structure 22 by at least one cable 26 or the like. A frame element (not shown) generally supports the components of the braking mechanism 10 and of the moving structure 22. In an operative or active mode, the moving assembly 20 operates by displacing the moving structure by activation of the actuating means 24.

The braking mechanism 10 comprises a generally vertical elongated member 28 secured preferably at both first and second ends 30, 32 to the frame element. The elongated member 28 includes at least one or a series of threads 34 which have a size, a shape and a pitch selected according to the type of load imposed on the movable assembly 20 and the speed range at which the moving structure 22 is allowed to move with respect to the surrounding area such as, for example, the elongated member 28 or the frame element. The elongated member 28 and the threads 30 generally vertically extend at least the vertical displacement of the moving structure 22. The elongated member 28 could be a threaded polygonal rod or shaft, or a braided cable. In the example of a braided cable, a strand (not shown) of the cable could also be removed to provide for a larger thread 34.

The braking mechanism 10 further comprises a guiding structure 36 with an interior cavity 38 is slidably connected to the elongated member 28 and is allowed to move freely there along. Preferably, holes (not shown) in the guiding structure 36 of a diameter larger than a diameter of the elongated member 28 could suffice for example. The guiding structure 36 of the braking mechanism 10 is secured to the moving structure 22 of the moving assembly 20 and moves there along with the moving structure 22 both in an upward direction or towards the first end 30 of the elongated member 28 and in a downward direction or towards the second end 32 of the elongated member 28 under normal operating conditions such as shown in FIG. 1. A roller bearing 40 or the like is preferably mounted in a lower part of the interior cavity 38 around the elongated member 28 to allow proper sliding of the ring 44 relative to the abuting surface of the structure 36. A disc 42 or washer or the like engagement element preferably made of rubber material or the like is preferably mounted in an upper part of the interior cavity 38 of the guiding structure 36. A ring 44 or the like is movably mounted on the elongated member 28 inside the cavity 38 of the guiding structure 36 between the roller bearing 40 and the disc 42. The material used for the ring 44 is preferably a metallic alloy or the like, thereby preferably having a relatively high coefficient of friction between the ring 44 and the disc 42. The ring 44 is provided with a coupling means cooperating with or coupling to the thread or threads 34 of the elongated member 28. As represented in FIG. 1a, the coupling means is preferably of the form of a portion of a mating thread or at least one or more internal protrusion 46, or tooth, or extremity of a bolt inserted radially into the ring 44, or a ball bearing, or the like, providing a relative movement between the ring 44 of the guiding structure 36 and the elongated member 28 that is generally smooth such that minimized friction forces are involved. If the ring 44 is vertically axially thick enough, one or more, typically three, protrusions 46 could be spirally and/or vertically spaced apart and therefore make the ring 44 axially more stable relative to the elongated member 28. Optionally, a proximity sensor 98, audible and/or visual (such as laser or the like), are provided intermediate the ring 44 and the disc 42 to monitor their relative movement thereby in use to initiate prior warning of imminent contact therebetween signaling exceeding speed of or failure in the moving structure or an emergency situation. The sensor(s) 98 is preferably mounted on the disc 42, and could alternatively be on the ring 44.

As one skilled in the art will understand, the ring 44 therefore rotates upwardly or downwardly along the elongated member 28 with respect to the displacement of the moving structure 22. The thread or threads 34 of the elongated member 28 are generally angled with respect to the direction of a force imposing the movement of the moving structure 22, and therefore of the ring 44, such that a component of this force is normal to the thread or threads 34 and another component is tangential to the thread or threads 34. That tangential component generally overcomes the friction between the elongated member 28 and the protrusion or protrusions 46 of the ring 44 of the guiding structure 36, allowing therefore a relative movement between the elongated member 28 and the ring 44. When no other forces are applied onto the guiding structure 36, the roller bearing 40 and the disc 42 do not hamper the displacement of the ring 44 and move with the guiding structure 36 and said ring 44 along the elongated member 28 as the moving structure 22 is displaced in operation of the moving assembly 20 and under normal speed conditions or in other words, in the active mode. As mentioned hereinabove, the physical characteristics of the ring 44 and the protrusion or protrusions 46 along with the size, shape and pitch selected for the thread or threads 34 of the elongated member 28 allows for the guiding structure 36 to be able to follow the moving speed of the moving axial structure 22 to which said guiding structure 36 is linked relative to the elongated member 28.

As more specifically represented in FIG. 2, in some unfortunate instances a malfunction occurs to the moving assembly 20. In the example, the cable 26 of the moving assembly 20 breaks as represented by an “x” in FIG. 2 and the numeral 48. The moving assembly 20 then turns into an inactive or non-operational mode. The gravity of the Earth then applies onto the moving structure 22 and provides a downward acceleration on said moving structure 22, as indicated by arrow A2. Unavoidably, the moving structure 22 reaches a speed that goes beyond the predetermined speed range for which the ring 44 is designed to follow for a smooth displacement. The displacement of the ring 44 somewhat falls behind the displacement of the moving structure 22 and the corresponding guiding structure 36 within the cavity 38. This variation of relative speed between the ring 44 and the guiding structure 36 brings a change of relative position of the ring 44 within the guiding structure 36. In other words, the bearing 40 moves away from the ring 44 and the disc 42 moves towards said ring 44.

As shown more specifically in FIG. 3, the braking mechanism 10 reaches a point where the disc 40 of the guiding structure 36 comes into contact and puts a downward direct pressure onto the ring 44. Since the ring 44 is forced to spiral down, this downward pressure changes the relation of forces within the components of the guiding structure 36. In such an instance and as one skilled in the art will understand, a frictional force is created between the disc 42 pushed to move downward by the gravity force given to the moving structure 22 and the ring 44 which is compelled to rotate around the elongated member 28 at a vertical displacement speed which is smaller than the speed and acceleration provided by the gravity onto the disc 42. This friction overcomes the circumferential or tangential component of the downward force produced on the rotational movement of the ring 44 and slows down the ring 44, and consequently the guiding structure 36 and the moving structure 22. By using appropriate physical characteristics for the material of the disc 42, the friction encountered between the disc 42 and the ring 44 is strong enough so as to stop completely the rotation of the ring 44, and consequently the downward displacement of the guiding structure 36 and of the moving structure 22. In other words, the frictional force between the disc 42 and the ring 44 overcomes the tangential component of the protrusion or protrusions 46 of the ring 44 on the thread or threads 30 of the elongated member 28. The disc 42 and the ring 44 therefore stop falling and block the fall of the guiding structure 36 and of the moving structure 22.

In an alternate embodiment of the braking mechanism (not shown), a biasing means (not shown) could be provided adjacent the ring 44 of the guiding structure 26 to enable proper displacement speed between the ring 44 and the elongated member 28 depending on the angular positioning of the thread or threads 34 on the elongated member 28.

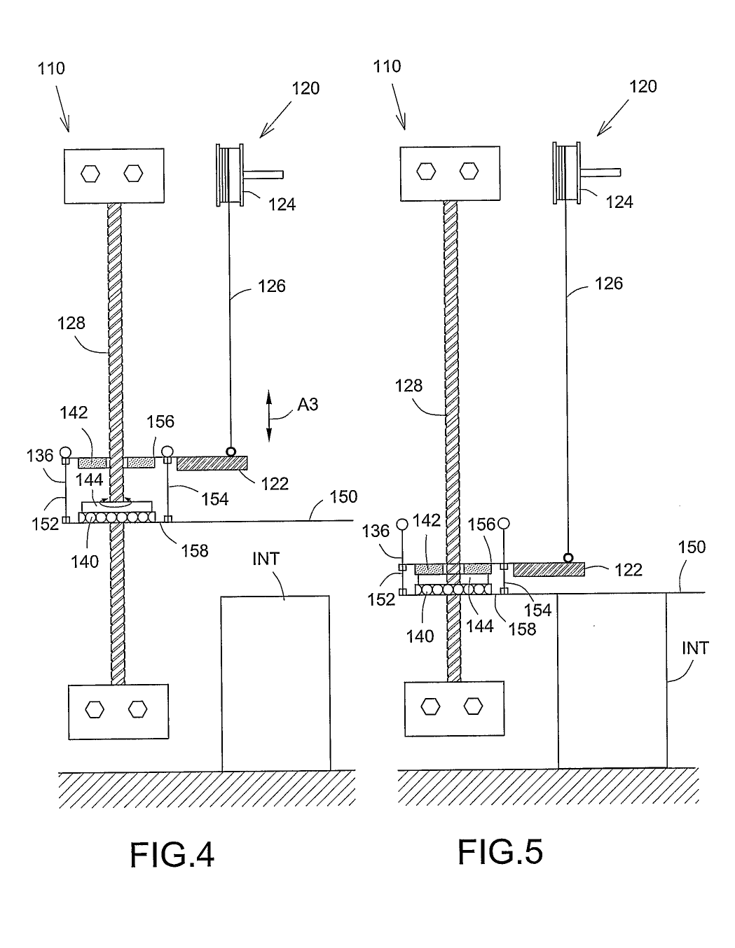

Braking mechanisms according to various embodiments of the present invention will now be described with respect to FIGS. 4 to 13. For concision purposes, only the differences between the braking mechanisms of the various embodiments of FIGS. 4 to 13 and the braking mechanism illustrated in FIGS. 1 through 3 will be described hereinbelow.

A braking mechanism 110 according to a second embodiment of the present invention is illustrated in FIGS. 4 and 5.

The guiding structure 136 mounted on the elongated member 128 of the braking mechanism 110 is provided with an extension 150 secured onto the guiding structure 136, preferably connected at a level in proximity with the bearing 140. The moving structure 122 of a moving assembly 120, linked by the cable 126 or the like to the actuating means 124 is also secured to the guiding structure 126, preferably connected at a level in proximity with the disc 142. In this particular embodiment, the guiding structure 136 preferably has side walls 152, 154 slidable within a top portion 156 of said guiding structure 136. The bearing 140 and the side walls 152, 154 are secured on the bottom portion 158 and the ring 144 rests generally adjacent the bearing 140. The moving structure 122 operates normally as shown in FIG. 4 and with the arrow A3.

FIG. 5 shows the moving assembly 120 and the braking mechanism 110 after an interference INT or object or the like in the path of the displacement of the extension 150 has been encountered by said extension 150 of the moving assembly 120. In other words, the interference INT must be in-between the first and second ends 30, 32 of the elongated member 28. In such an instance, the lower portion 158 of the guiding structure 136 is blocked from further downward displacement. The ring 144 is prevented from rotating downwardly and therefore also stops in place. The top portion 156 and the disc 142 within the cavity 138 continue to move downwardly along with the moving structure 122 since the top portion 156 is allowed to slide onto the side walls 152, 154. As one skilled in the art will understand, when the disc 142 reaches the ring 144, the braking mechanism 110 fully engages as previously described, and the moving structure 122 is prevented from further downward displacement. The system is designed in such a way so that when the braking system 110 is fully engaged, the level at which the moving structure 122 is secured on the guiding structure 136 has not reached yet the level of the extension 150, thereby preventing damage to the moving structure 122, objects or persons carried thereon, or any component of the moving assembly 120.

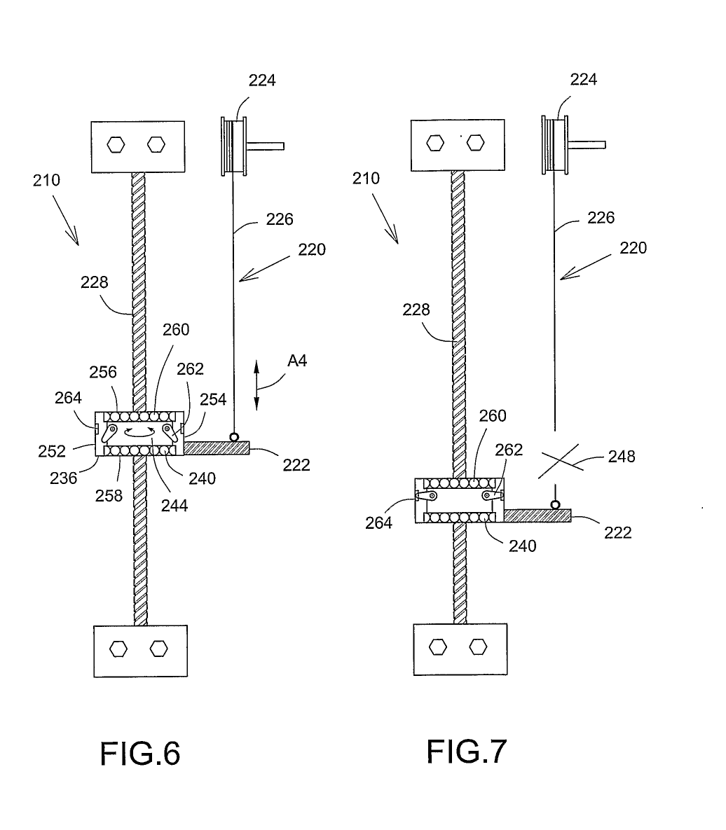

A braking mechanism 210 according to a third embodiment of the present invention is illustrated in FIGS. 6 and 7.

The operating moving assembly 220 shown in FIG. 6 comprises the moving structure 222 linked to the guiding structure 236 and to the actuating means 224 by a cable 226 or the like. The guiding structure 236 mounted on the elongated member 228 comprises the first bearing 240 mounted in the bottom section 258 and a second bearing 260 mounted in the top portion 256. The ring 244 is preferably inserted in-between the first and second bearings 240, 260 and comprises at least one pivotally mounted arm 262, two of which are represented in FIGS. 6 and 7, and which is so configured as to move under centrifugal force. The side walls 252, 254 comprise at least one abutment 264, one for each pivoting arm 262 and two of which are represented in FIGS. 6 and 7. Under normal operating conditions, the abutments 264 do not obstruct the pivoting arms 262 of the ring 244 that are subject to the displacement of the moving structure 222 and of the guiding structure 236 as represented by arrow A4.

As more specifically represented in FIG. 7, in some unfortunate circumstances a malfunction occurs to the moving assembly 220. In the example, the cable 226 ruptures as represented by an “x” and the numeral 248. The force of gravity is then applied onto the moving structure 220 and onto the corresponding guiding structure 236. Under the higher speed and acceleration provided in the downward displacement of the ring 244, the centrifugal force applied to each arm 262 increases and forces the arm 262 to pivot. As one skilled in the art will understand, when the arms 262 are elevated sufficiently, the abutments 264 of the side walls 252, 254 obstruct said arms 262 thereby stopping the rotation of the ring 244. As long as the friction forces created between the arms 262 and the abutments 264, the braking mechanism 210 remains activated and the moving assembly 220 stays in place.

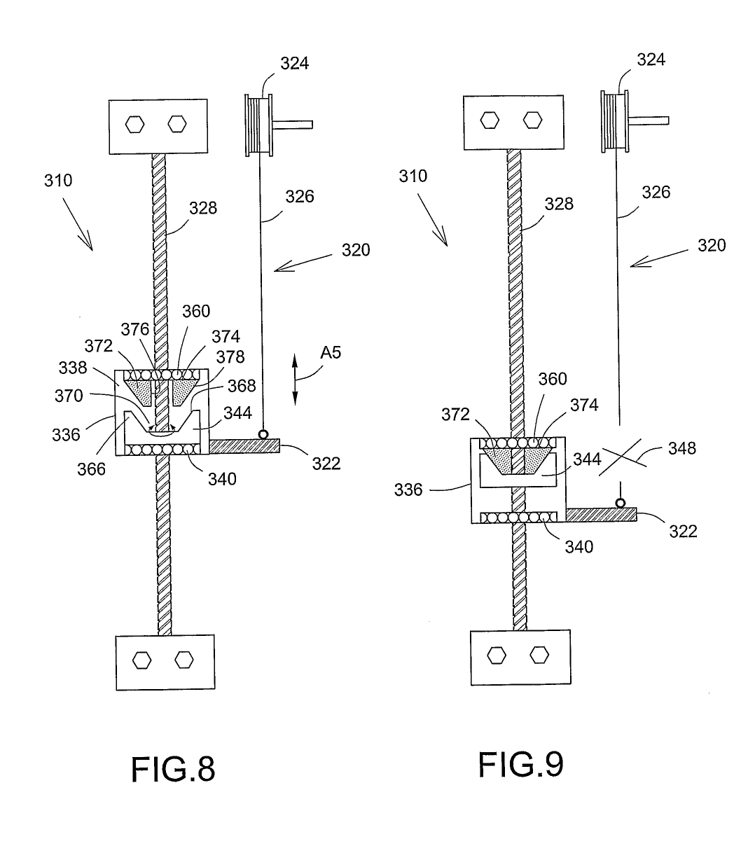

A braking mechanism 310 according to a fourth embodiment of the present invention is illustrated in FIGS. 8 and 9.

The operating moving assembly 320 shown in FIG. 8 comprises the moving structure 322 linked to the guiding structure 336 and to the actuating means 324 by a cable 326 or the like, and the generally allowed displacement as represented by arrow A5. The guiding structure 336 comprises the first and second bearings 340 and 360. The ring 344 adjacent the first bearing 340 in normal operating conditions comprises preferably an upper inversed-conical section 366 wherein a ring tapered wall 368 extends generally upwardly and outwardly from the axial direction represented by the elongated member 328 and creates a conical cavity 370 in-between said ring tapered wall 368. The guiding structure 336 also includes a clamp 372 or the like, acting as an engagement element, secured in close proximity to the second bearing 360 inside the cavity 338. The clamp 372 has an axially slidable upper base 374 and a generally vertical interior side wall 376, said interior side wall 376 generally parallel to the elongated member 328. The clamp 372 also comprises a generally conical clamp tapered wall 378 extending generally downwardly and inwardly towards the axial direction represented by the elongated member 328 and at an angle generally mating the angle of the ring tapered wall 368 of the upper inversed-conical section 366 of the ring 344.

FIG. 9 shows the braking mechanism 310 and the moving assembly 320 after a malfunction occurs, in this example, a rupture of the cable 326 and represented by an “x” and by numeral 348. Similarly to the first embodiment shown in FIG. 3, the second bearing 360 and the clamp 372 move downwardly more rapidly due to the gravity force on the connected moving structure 322 than the ring 344 rotates downwardly, thereby closing the gap within the cavity 338 of the guiding structure 336. As one skilled in the art will understand, the clamp 372 enters the conical cavity 370 of the ring 344. Furthermore, the ring tapered wall 368 of the ring 344 enters in contact with the mating clamp tapered wall 378 of the clamp 372, forcing the upper base 374 to axially slide towards the elongated member 328. The interior side wall 376 of the clamp 372 then enters in contact with the elongated member 328 and creates a friction there between, thereby increasing furthermore the friction in-between the ring tapered wall 368 and the clamp tapered wall 378 up to a point where the ring 344 stops rotating around the elongated member 328, thereby preventing the guiding structure 336 and the moving structure 322 to go down further.

As one skilled in the art will understand, an alternate braking mechanism (not shown) could be provided with a clamp (not shown) sliding outwardly and entering in contact to create friction with an outer track (not shown) or the likes rather than with the central elongated member 328.

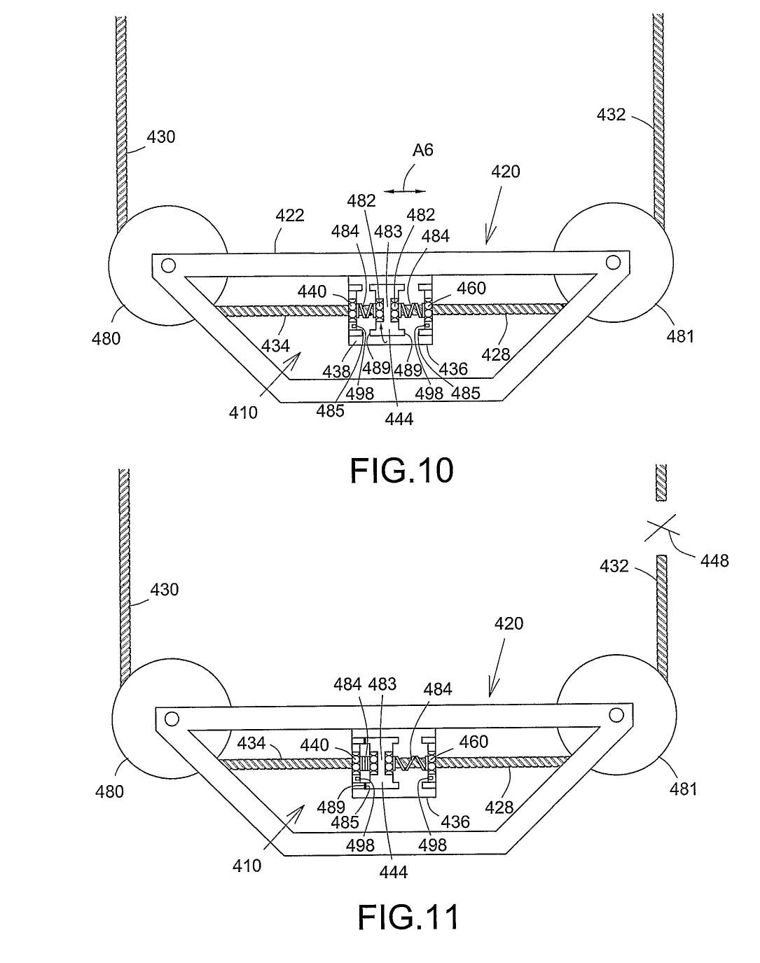

A braking mechanism 410 according to a fifth embodiment of the present invention is illustrated in FIGS. 10 and 11.

FIG. 10 represents the moving assembly 420 or bridge crane or the like operating in normal conditions, with a generally horizontal displacement as indicated by arrow A6. The guiding structure 436 is secured to the moving structure 422. Preferably two elongated members 428, one of which is shown, support the moving structure 422 with preferably pairs of pulleys, two of which are shown at the numeral 480 and 481. An actuating means (not shown) can activate the system as it is well known in the art, and relatively move the moving structure 422 towards the first end 430 or the second end 432 of the elongated member 428. The guiding structure 436 comprises the first and second bearing 440 and 460 attached thereto for allowing its axial displacement relative to the elongated member 428, and the ring 444 within the cavity 438 of the guiding structure 436. The ring 444 comprises a pair of bearings 482 mounted thereon and onto the elongated member 428, each bearing 482 separated from the other bearing 482 by adjacent protrusion section 483 wherein the protrusion or protrusions (not shown) is in coupling means with the thread or threads 434 of the elongated member 428. A biasing means 484 or spring or the like is positioned between each first and second bearing 440 and 460 and the respective adjacent bearing 482 of the ring 444, and mounted on the elongated member 428. The springs 484 helps making the generally horizontal displacement of the ring 44 relative to the elongated member 428 substantially uniform when the moving assembly 420 is operating under normal conditions. Furthermore, a coupling dented crown 485 or the like is attached to the guiding structure 436 adjacent each bearing 440, 460 adjacent for operationally meshing with corresponding dented crowns 489 of the ring 444 adjacent both bearings 482.

FIG. 11 shows the braking mechanism 410 and the moving assembly 420 after a malfunction occurs, in this example, a rupture of one of the elongated members 428 in proximity to the second end 432 and represented by an “x” and by numeral 448. As one skilled in the art will understand, in such instances, the new forces applied relatively move the ring 444 within the guiding structure 436, in this case towards the first bearing 440. Even if the guiding structure 436 is mounted generally horizontally, the same forces apply as described in the previous embodiments. The spring 484 acts as a buffer between the ring 444 and the bearing 440 until such moment wherein the resulting force is too strong and the spring 484 is sufficiently compressed to enable the coupling crowns 485 and 489 of the respective bearings 440 and 484 to mesh with one another, thereby stopping the rotation of the ring 444 and the accelerated displacement of the moving structure 422 of the moving assembly 420.

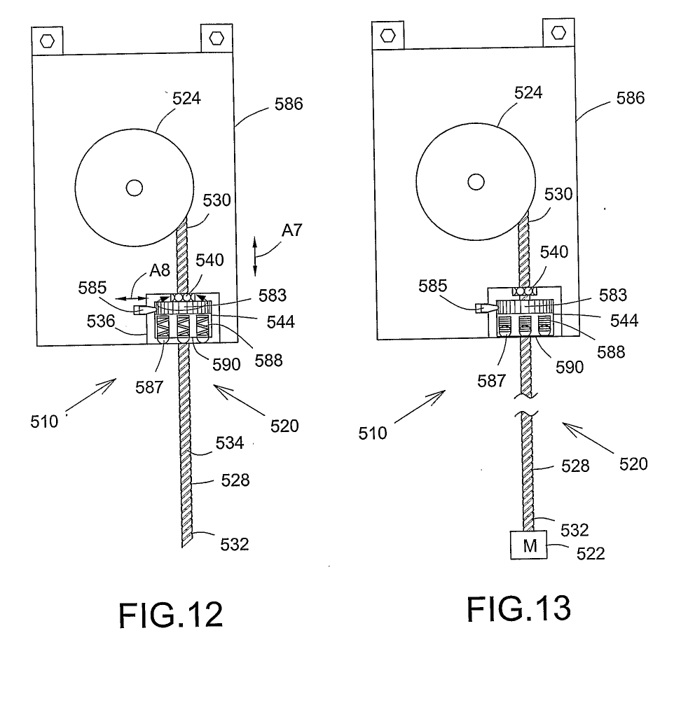

A braking mechanism 510 according to a sixth embodiment of the present invention is illustrated in FIGS. 12 and 13.

FIG. 12 represents the moving assembly 520 or lifeline or the likes in normal conditions, with a generally displacement indicated by arrow A7. The winding rod 524 or the like activates the displacement of the elongated member 528. The winding rod 524 and the guiding structure 536 are secured to a structure 586, platform or the like. The guiding structure 536 comprises the bearing 540 in proximity to the first end 530 of the elongated member 528 and the ring 544. The ring 544 further comprises preferably a thrust bearing 587 or the like in proximity to the second end 532 allowing the rotational movement of the ring 544 along with the protrusion section 583 wherein the protrusion or protrusions (not shown) are in coupling means with the thread or threads 534 of the elongated member 528. The ring 544 further includes biasing means 588, such as springs or the like, mounted on the thrust bearing 587.

FIG. 13 shows the braking mechanism 510 and the moving assembly 520 after a sudden force is transmitted to the elongated member 528 such as when the moving structure 522 of a mass M, for example a person, falls suddenly from the platform 586. As one skilled in the art will understand, the gravitational force of the Earth applied in this example onto the mass M changes the relation of forces within the guiding structure 536. The ring 544 is displaced towards the tension applied onto the elongated member 528, thereby compressing the springs 588 until such a time where said springs 588 are fully compressed and the forces acting on the thrust bearing 587 such that the bottom surface 590 of the ring 544 frictionally prevents the rotation of the ring 544 relative to the guiding structure 536, acting as an engagement element, and the structure 586, thereby rotationally blocking said ring 544 in place and stopping the longitudinal displacement of the elongated member 528 relative thereto to counterbalance the force applied onto the elongated member 528 by the mass M.

In order to ensure rotation of the ring 544 in only one direction, a mechanical locking, preferably manually activated (as indicated by the adjacent double rectilinear arrow A8 in FIG. 12), may be adopted, such for example as a ratchet arrangement 585 appropriately disposed as between the ring 544 and the engagement element 536. The pin component of the ratchet 585 is shown has being engaged in FIG. 12 (and disengaged in FIG. 13) to the corresponding teeth located on the protrusion section 583 of the ring 544.

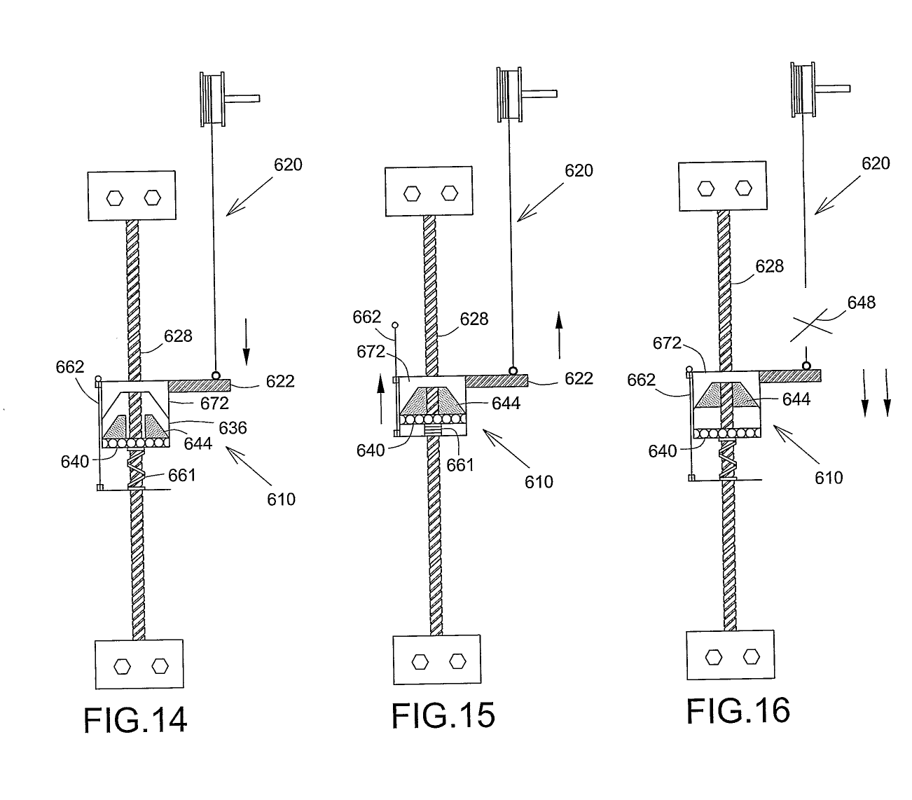

FIG. 14 shows the braking mechanism 610 associated with the elongated member 628 and the moving assembly 620 during a normal mode of operation, the ring 644 being displaced from the engagement element in the form of the clamp 672, acting as an engagement element, and carried by bearing 640, the guide structure 652 being secured to the moving structure 622, and a spring support 661 being disposed subjacent the bearing 660. In this embodiment the ring 644 could be produced from a high friction material for example rubber. A pneumatic, hydraulic, electromagnetic or equivalent externally (by operator or the like) activated safety mechanism 662 is shown diagrammatically as being associated with the spring support 661.

In FIG. 15 the braking mechanism is shown in an almost activated and full safety mode with the safety mechanism 662 having been operated to raise the spring support 661 and the bearing 660 in such manner as to position the ring 644 in a close proximity with the clamp 672 to enable instantaneous (without backlash or jerk) engagement there between in case of activation of the braking mechanism 610 to effect immediate braking of the moving assembly 620, the spring being almost fully compressed as shown.

In FIG. 16 the braking mechanism has been automatically activated following a rupture 648 in the drive cable 626; on this occasion the ring 644 and the clamp 672 are fully in frictional engagement, but the spring support 661 remains in its open coil condition.

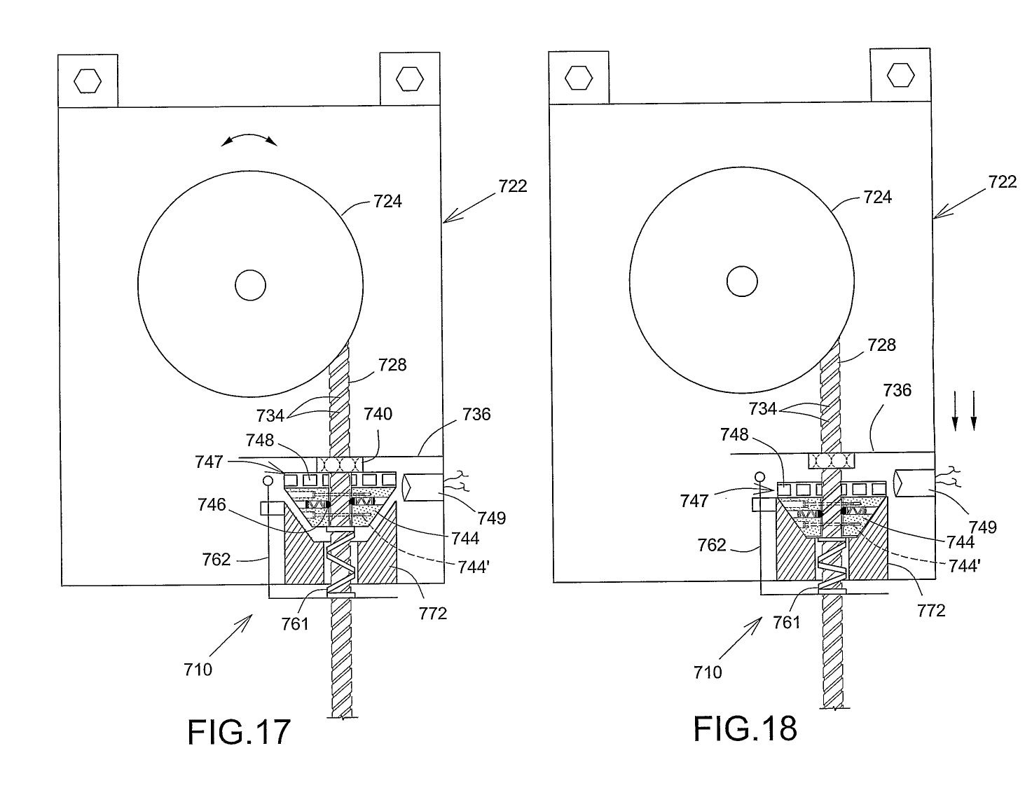

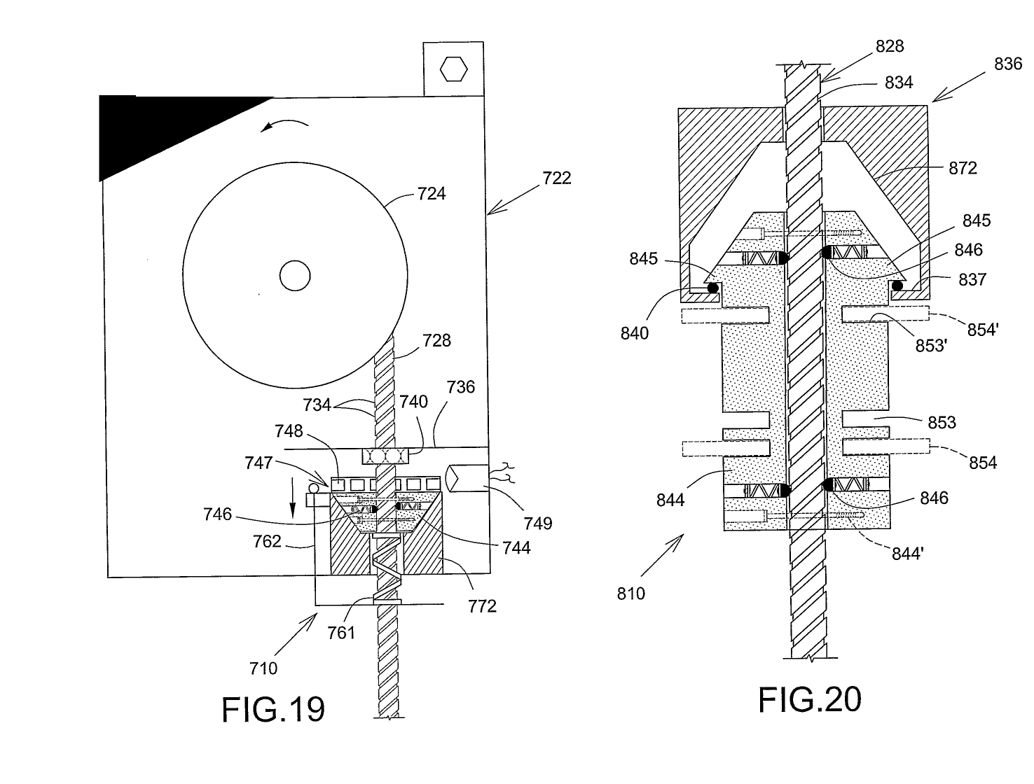

Referring now to FIGS. 17, 18 and 19 the elongated member 728 is a drive rope or life line reeved around a winch drum 724 with the braking mechanism 710 associated with the rope 728. In this instance, the braking mechanism 710 includes a guiding structure 736 having a top bearing 740. The ring 744 is of inverted frusto-conical form with spring loaded coupling elements or ball 746 engaging, substantially without friction, the scroll strands 734 of the member 728. The ring 744 also carries a collar 747 which may include a series of magnets or mirrors 748 for interaction with an appropriate magnetic or light detector 749 for detecting motion of the ring, such as a zero speed switch, kill switch or the like. A clamp 772 of mating frusto-conical form is provided as shown with a spring support 761 interacting with a pneumatic or other equivalent safety mechanism 762, which may be activated to give a full safety mode ready to instantly operate as shown in FIG. 19.

The ring 744 is made out of two similar sections connected to each other via internal screws 744′ or the like. Such an arrangement allows the control of the gap between each section and the elongated member 728, which, upon activation of the mechanism 710, could ensure a desired frictional contact between the ring sections and the elongated member 728.

Referring now to FIG. 20, there is illustrated schematically a braking mechanism 810 suitable for application to a physical exercise machine (not shown) employing a system of weights which a user is intended to lift in order to improve fitness and to effect muscle development. The user is able to select how the degree of loading and to this end the weights may be sequentially added in accordance with requirements. In this example the elongated member is represented at 828 and is provided with the scroll 834 with a ring 844 provided with the coupling means in the form of spring-loaded fingers or balls 846 engaging the scroll as shown. The ring 844 has a frusto-conical head 845 for mating engagement in a retardation or arrest mode with a correspondingly shaped clamp 872 in female form within a guide structure 836, the ring and the clamp being able freely to move along and around the member 828 during normal operation. The guide structure 836 has an internal lip 837 and a bearing 840 is provided intermediate the lip and a shoulder 845 on the ring. In this connection, the ring 844 is provided with relatively deep circumferential grooves 853 for the reception of small weights 854 (shown in dotted lines) which would modulate the rate of descent of the ring 844 as the user raises and lowers the main weights (not shown). Other factors such as the tension in the springs of the protruding balls 846, the gap between the two ring sections as controlled by the screws 844′ and the pitch angle of the scroll thread 834 could be tuned to control the maximum rate of descent or the ring 844.

In operation the guide structure is connected to, and is thus raised and lowered in tandem with the elevation and descent of, a weight carrying platform (not shown) with which the user exercises. During elevation the ring 844 spins on the scroll 834 of the member 828 and is assisted in this motion by the bearing 840. During the lowering action in normal circumstances, the ring 844 and the guide structure 836 move downwardly in tandem, again the ring spinning around the scroll and moving in descent therealong. In other circumstances when for example the user is unable to hold the loading of the main weights on the platform, the structure 836 will descend faster than the spinning ring 844 until it contacts the ring and interengagement of the clamp 872 and the ring is effected thereby to decelerate and to arrest the platform, thereby preventing injury to the user. The braking mechanism also operates in this fashion in the event of any failure of the lifting arrangements for the main weights, for example the usual suspension wire.

It will be understood that where an elastomeric material is deployed as the engagement element, during the braking mode the material not only frictionally engages the ring but could also deform to contact the elongated member thus enhancing the decelerative and arrest effect.

The braking mechanism 810 (and other embodiments) could be used on a section of the elongated member running down when the weights are lifted up to control the rate of ascent of the weights.

An uppermost circumferential groove 853′ located adjacent and below the lip 837 can be used to deactivate the braking mechanism 810 by having a blocking small weight 854′ or the like engaged therein and protruding underneath the lip 837 to prevent upward movement of the ring 844 relative to the clamp 872 of the structure 836. Obviously, to prevent the small weights 854 from blocking the mechanism 810, the corresponding slots 853 are located below and sufficiently spaced apart from the uppermost slot 853′.

In all embodiments the ring is freely able to rotate or spin around the elongated member during normal operation and under the influence of gravity where the brake mechanism is vertically orientated. During an emergency scenario, the guide structure and thus the engagement element essentially catch up with the spinning ring and frictional contact with the ring prevents further rotation thereof thus bringing the moving structure to a halt. In a horizontal orientation of the braking mechanism, a biasing coil spring acts on the ring to maintain the latter away from the engagement element, upon failure of the elongated member, the acceleration of the elongated member counteracts the spring biasing force to allow contact between the ring and the engagement element to bring the moving structure to a halt.

In any of the moving assemblies 20, 120, 220, 320, 430, and 520 presented hereinabove, one skilled in the art will understand that a safety feature such as a kill switch 749 or the like is preferably present to, typically electronically, disconnect for example the actuating means 24, 124, 224, 324, 424 or 524, along with any combined actuating means operating in parallel for example, when the braking mechanism 10, 110, 210, 310, 410 or 510 is activated. In an alternative embodiment of the braking mechanism 10, a kill switch 749 is linked to the actuating means 24. An electromagnet 748 mounted on the ring 44 links said ring 44 to the bearing 40. When an electricity stoppage occurs, the ring 44 is separated from the bearing 40 as shown in FIG. 2 thereby activating the braking mechanism 10. One skilled in the art will also understand that the braking mechanisms 10, 110, 210, 310, 410, 510, 610, 710 and 810 herein disclosed could be mounted on similar systems not presented, such as for example on a hydraulic system or on a system using pressure valves.

Furthermore, to disengage the braking mechanisms 10, 110, 210, 310, 410, 510, 610, 710 and 810 illustrated hereinabove when the system has been fixed or the emergency forces withdrawn, an initial motion in a general direction opposed from where the emergency forces came from must be applied onto the guiding structures 36, 136, 236, 336, 436, 536, 636, 736 and 836.

Although not illustrated in all embodiments, one skilled in the art would understand that instead of frictional engagement between the ring 44, 144, 344, 544, 644, 744 and 844 and a corresponding facing surface there could be meshing teeth to actually stop the rotational displacement relative to one another without deviating from the scope of the present invention, and vice-versa for rings 244 and 444.

It will be appreciated that the present invention is also functional bi-directionally and thus would operate for example if the moving structure were to accelerate in its ascent mode as well as in its descent mode.

The skilled addressee will recognize that the present invention represents a clear departure from the prior art in terms of its construction and operational modes and indeed its simplicity. Further, the invention is versatile and thus has a wide applicability to all manner of moving structures that might be susceptible to emergency situations.

Although the present braking mechanisms 10, 110, 210, 310, 410, 510, 610, 710 and 810 have been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

1. A braking mechanism (10, 110, 210, 310, 410, 510, 610, 710, 810) adapted for connection to a moving structure (22, 122, 222, 322, 422, 522, 622, 722) of a moving assembly, the braking mechanism comprising an elongated member (28, 128, 228, 328, 428, 528, 628, 728, 828) and a guiding structure (36, 136, 236, 336, 436, 536, 636, 736, 836) characterized by the guiding structure (36, 136, 236, 336, 436, 536, 636, 736, 836) being connectable to the moving structure (22, 122, 222, 322, 422, 522, 622, 722) and freely movable axially along the elongated member (28, 128, 228, 328, 428, 528, 628, 728, 828) and comprising a ring (44, 144, 244, 344, 444, 544, 644, 744, 844) connected by a coupling means (46, 746, 846) to the elongated member (28, 128, 228, 328, 428, 528, 628, 728, 828), the coupling means (46, 746, 846) in use allowing unimpeded rotation of the ring (44, 144, 244, 344, 444, 544, 644, 744, 844) around and displacement thereof along the elongated member (28, 128, 228, 328, 428, 528, 628, 728, 828) when the moving structure axially moves at or below a predetermined speed, the guiding structure (36, 136, 236, 336, 436, 536, 636, 736, 836) further comprising an engagement element (42, 142, 242, 372, 485, 536, 672, 772, 872) engageable with the ring (44, 144, 244, 344, 444, 544, 644, 744, 844) when the moving structure (22, 122, 222, 322, 422, 522, 622, 722) moves above the predetermined speed thereby generating a rotation resistance force therebetween, whereby the rotation resistance force slowing down or arresting the displacement of the ring (44, 144, 244, 344, 444, 544, 644, 744, 844) and of the guiding structure (36, 136, 236, 336, 436, 536, 636, 736, 836) on the elongated member (28, 128, 228, 328, 428, 528, 628, 728, 828), and of the moving structure (22, 122, 222, 322, 422, 522, 622, 722) of the moving assembly.

2. A braking mechanism according to claim 1 characterized in that the engagement element (42, 142, 242, 372, 485, 587, 672, 772, 872) is frictionally engageable with the ring (44, 144, 244, 344, 444, 544, 644, 744, 844) when the moving structure (22, 122, 222, 322, 422, 522, 622, 722) moves above the predetermined speed thereby generating a frictional rotation resistance force therebetween.

3. A braking mechanism according to any one of claims 1 and 2 characterized in that the ring (44, 144) and the engagement element (42, 142) are of planar form.

4. A braking mechanism according to any one of claims 1 and 2 characterized in that the ring (344, 644, 744, 844) and the engagement element (342, 672, 772, 872) are for frusto-conical form with a respective one of the ring and the engagement element being for male or female coupling.

5. A braking mechanism according to claim 4 characterized in that the frusto-conical form may be normally presented or inverted.

6. A braking mechanism according to any one of claims 2 to 5 characterized in that the engagement element (22, 122, 222, 322, 422, 522, 672, 772, 872) and/or the ring (44, 144, 244, 344, 444, 544, 644, 744, 844) is of high friction material.

7. A braking mechanism according to claim 6 characterized in that the high friction material is rubber.

8. A braking mechanism according to any one of the preceding claims characterized in that the elongated member (28, 128, 228, 328, 628) is a rigid rod provided with a scroll for mating association with the coupling means on the ring.

9. A braking mechanism according to any one of the preceding claims 1 to 7 characterized in that the elongated member (428, 528, 728, 828) is relatively flexible.

10. A braking mechanism according to claim 9 characterized in that the elongated member (428, 528, 728, 828) is a wire rope with sufficient scroll to enable functioning of the coupling means on the ring to engage the rope.

11. A braking mechanism according to any one of the preceding claims characterized in that the guiding structure (36, 136, 236, 336, 436, 536, 636, 736, 836) includes a bearing arrangement (40, 140, 240, 340, 440, 540, 640, 740, 840) circumscribing the elongated member (28, 128, 228, 328, 428, 528, 628, 728, 828) and in use capable during normal ascent or movement of the structure, of contacting and supporting the ring during its rotation about the elongated member.

12. A braking mechanism according to any one of the preceding claims characterized in that the ring (844) is provided with mounting means (853) for weights for the purpose of adjusting the rate of descent in use of the ring (844) along the elongated member.

13. A braking mechanism according to any one of the preceding claims characterized in that an externally activated safety mechanism (662, 762) is provided to position the ring (644, 744) in a close proximity with the engagement element (672, 772) to enable instantaneous engagement therebetween, the safety mechanism being optionally actuable dependent upon the degree of braking security required.

14. A braking mechanism according to claim 13 characterized in that the externally activated safety mechanism (662, 762) is provided to give assistance to secure the ring (644, 744) and the engagement element (672, 772) in contact engagement during the arresting mode.

15. A braking mechanism according to any one of claims 13 and 14 characterized in that the safety mechanism is pneumatically or hydraulically or electromagnetically activated.

16. A braking mechanism according to any one of the preceding claims 1 to 13 characterized in that a mechanical locking means (583) is provided to interact between the ring (544) and the engagement element (536) when desired.

17. A braking mechanism according to any one of the preceding claims characterized in that the ring (444, 544, 644, 744) or the engagement element is resiliently supported (484, 588, 661, 761).

18. A braking mechanism according to any one of the preceding claims characterized in that sensors (98, 498) are provided intermediate the ring (44, 444) and the engagement element (42, 485) to monitor their relative movement thereby in use to initiate prior warning of imminent contact therebetween signaling failure in the moving structure or an emergency situation.

19. A braking mechanism according to claim 1 characterized in that the ring (244) comprises at least one pivotally mounted arm (262) and the guiding structure (236) is provided with at least one abutment (264) constituting the engagement element whereby in use upon attainment of a predetermined speed of ring movement in relation to the elongated member (228) the arm (262) contacts and engages the abutment (264) in order to effect deceleration and arrest of the ring (244) and thus of the moving structure (222).

20. A braking mechanism adapted for connection to a moving structure (122) of a moving assembly, the braking mechanism (110) comprising an elongated member (128) and a guiding structure (136) characterized by the guiding structure (136) being connectable to the moving structure (122) and freely movable axially along the elongated member (128) and comprising a ring (144) connected by a coupling means to the elongated member (128), the coupling means in use allowing unimpeded rotation of the ring (144) around and displacement thereof along the elongated member (128) when the moving structure (122) axially moves at or below a predetermined speed, the guiding structure (136) further comprising an extension (150) and an engagement element (142) mounted thereon, said engagement element (142) engaging the ring (144) upon said extension (150) contacting an obstruction (INT), thereby generating a frictional force between the ring (144) and the engagement element (142), the frictional force slowing down or arresting the displacement of the ring (144) and of the guiding structure (136) on the elongated member (128), and of the moving structure (122) of the moving assembly.
